(19) United States
(12) Patent Application Publication
(10) Pub. No.: US 2010/0278695 A1
(43) Pub. Date: Nov. 4, 2010

(54) Chromatographic And Electrophoretic Separation Media And Apparatus

(75) Inventors: David Alden Piper, Leominster, MA (US); Joseph A. Kareh, Westwood, MA (US)

Correspondence Address: Waters Technologies Corporation, 34 MAPLE STREET - LG, MILFORD, MA, 01757, US

(73) Assignee: WATERS TECHNOLOGIES CORPORATION, Milford, MA (US)

(21) Appl. No.: 12/598,678

(22) PCT Filed: May 6, 2008
(86) PCT No.: PCT/US08/62737

§ 371 Date: Feb. 25, 2010

Related U.S. Application Data
(60) Provisional application No. 60/916,611, filed on May 8, 2007.

(51) Int. Cl. B01J 20/22; B01D 15/08; G01N 30/02; B01J 20/02; B01J 20/26

(52) U.S. Cl. 422/70; 210/198.2; 210/290; 204/647; 210/149; 502/1

(57) ABSTRACT

The invention provides improved separation media for use in chromatography and electrophoresis, or for the selective absorption of certain components of a sample mixture, especially in a preliminary stage of an analysis. Improved media according to the invention comprises first particles capable or retaining one or more of the components of a sample mixture and second particles selected to have a higher thermal conductivity than the first particles, so that the thermal conductivity of the media is higher than that of media comprising the first particles alone. The media may be incorporated in packed or capillary columns for chromatography (especially nanoflow HPLC) or for capillary electrophoresis, or may be coated on a substrate. Particular embodiments of the media may comprise mixtures of first particles comprising siliceous polymers, second particles of gold, diamond or graphite. Chromatographic columns and apparatus incorporating them are also disclosed.

### CROSS REFERENCE RELATED APPLICATION

This application claims priority from U.S. Provisional Patent Application No. 60/916,611, filed May 8, 2007. The contents of these applications are incorporated herein by reference.

### STATEMENT REGARDING FEDERAL SPONSORSHIP

This invention was made without Federal sponsorship.

### FIELD OF THE INVENTION

This invention relates to chromatographic separation media and to media for selectively absorbing certain chemical species, especially for analytical purposes. The media are useful in liquid chromatography, supercritical fluid chromatography and electrochromatography or electrophoresis, especially for the types of high pressure liquid chromatography and chromatography at extreme pressures of greater than 5,000 pounds per square inch (PSI), nanoflow LC, and microbore LC.

### BACKGROUND OF THE INVENTION

Mixtures comprising components having different chemical structures are frequently separated for analytical or preparative purposes by chromatography. An aliquot of such a mixture may be introduced into a mobile phase (which may be gas, liquid or a supercritical fluid). The mobile phase is caused to flow through a stationary phase comprising separation media. Components of the mixture may interact differently with the separation media and may be retained by it for different periods. Components may therefore elute from the separation media at different times and may be collected or detected by any means responsive to a selected property of the components of interest. As used herein, the term “sample” is directed to the solutions and mixtures which are analysed to determine one or more components of interest.

Mobile phase may be caused to flow through the separation media by virtue of its pressure (if a gas or supercritical fluid), by pumping, or by the influence of an electrical field (in electrochromatography or capillary electrophoresis). A combination of these processes may also be used.

In a related technique, a complex mixture can be separated by depositing it on separation media (typically a gel) supported on a surface, and causing the components comprised in the mixture to migrate through the media by means of an electrical field. A variety of different techniques may then be used to mark the positions of different components in the media after the field has been applied for a given time. Certain components in a complex mixture may also be selectively absorbed on separation media in order to separate them from unwanted components, and then analysed using other techniques, for example mass spectrometry or other spectroscopic techniques.

Chromatographic separation media may comprise small particles packed in a tubular column (usually made of stainless steel or fused silica) or may comprise a coating on the interior wall of a capillary tube. Some current columns comprise particles as small as 1 micron and operate at pressures as high as 15,000-100,000 psi. Although these columns generally exhibit greater separation efficiency than columns comprising larger particles, it is thought that still greater efficiency could be realised by the use of separation media more suited to the high pressures used.

In general, the efficiency of all such separation techniques is to some extent dependent on the nature of the separation media. The present invention relates to improved separation media particularly suitable for use at very high pressure of a chromatographic mobile phase, but which also may advantageously be used in a variety of other techniques to improve the separation of components in complex mixtures.

### SUMMARY OF THE INVENTION

The inventors have found that, particularly in the case of chromatographic separations carried out at very high pressure, increasing the thermal conductivity of prior types of separation media, or adding material of high thermal conductivity to the separation media, improves the separation efficiency of that media. The invention therefore provides improved separation media for use in the chromatographic separation of a sample mixture. The separation media comprises first particles of a first material and second particles of a second material. The first particles are capable of at least temporarily retaining at least one component of a sample mixture. The second material is selected to have a higher thermal conductivity than said first material.

A further embodiment of the invention is directed to an apparatus for the chromatographic separation of a sample mixture comprising a tubular member having an inlet through which a fluid may enter and an outlet through which fluid may leave. The tubular member has an interior space disposed between the inlet and the outlet, wherein there is disposed in such interior space, a separation media comprising first particles of a first material and second particles of a second material. The first particles are capable of at least temporarily retaining at least one component of the sample mixture. The second material is selected to have a higher thermal conductivity than the first material.

Another embodiment of the invention is directed to apparatus for selectively absorbing at least one component of a sample mixture on separation media. The apparatus comprises means for supplying a fluid which fluid is or carries the sample mixture to the separation media. The separation media has first particles of a first material and second particles of a second material. The first particles are capable of at least temporarily retaining at least one component of the sample mixture and the second material is selected to have a higher thermal conductivity than the first material.

Preferably, the first particles of a first material comprise particles of a material conventionally used in prior types of chromatographic columns, for example silica, organic polymers, siliceous polymers, graphite. These particles are coated or uncoated. As used herein, the term “coating” refers to a layer or reaction product of the particle surface with chemical agents to bond chemically functional moieties. Such moieties may comprise alkyl, aryl, phenyl or carbamate groups, or other groups used in prior types of separation media. The first particles are porous or non-porous. The first particles are sized between 1 micron and 100 microns, but most preferably are between 1 and 10 microns. The first particles are any shape including irregular shapes, but preferably are approximately spherical.

The second particles comprise the second material that has a higher thermal conductivity than the material of which the first particles are comprised. Preferably, the second material is a metal; such as gold, silver, aluminium, copper, tungsten, and molybdenum; carbon allotropes, especially various forms of diamond; and ceramics, such as alumina, aluminium nitride, titanium carbide, silicon carbide, or zirconium oxide.

Preferably, the second material has a thermal conductivity greater than 0.5 W·cm⁻¹·° K⁻¹, and, most preferably, greater than 1 W·cm⁻¹·° K⁻¹. Preferably, the thermal conductivity of the second material is approximately tenfold greater than that of the first material.

Preferably, the first and second particles are approximately the same size. The first particles are normally sized as the particles that might be used to prepare prior types of separation media comprising only the first particles.

Preferably, approximately 1% and 25% of separation media comprise the second particles. The remainder of the separation media is the first particles. A more preferred range is between 5% and 20% of the separation media is the second particles; and, more preferred, about 10%.

Preferably, the first particles are responsible for the at least temporary retention of components of a sample by the separation media. The second particles are primarily added to increase the thermal conductivity of the substrate to a value greater than that of the first particles alone. However, those skilled in the art will recognise that the second particles also interact with components of the sample and for at least some of those components to be at least temporarily retained by the second particles.

The inventors have found that by the use of separation media as described, the performance of high-pressure liquid chromatography in particular can be significantly improved. For example, the separation between two chromatographic peaks which are poorly resolved using separation media comprising only the first particles can be significantly improved using separation media comprising high thermal conductivity second particles in addition to the first particles, using otherwise similar chromatographic conditions.

Without wishing to be bound by theory, the inventors believe that the use of separation media according to the invention may reduce the detrimental effect of frictional heating that is thought to take place at very high pressure. It is speculated that the use of separation media having a higher thermal conductivity than that of the first particles alone can reduce the thermal gradients in the mobile phase that are probably caused by this heating and in so doing increase the resolution of the separation.

Other features and advantages of the present invention will be apparent to those skilled in the art upon reading the detailed description and viewing the Figures that follow.

### BRIEF DESCRIPTION OF THE FIGURES

Embodiments of the invention will now be described in detail with reference to the figures, in which:

FIG. 1 is a schematic representation of one embodiment of separation media according to the invention;

FIG. 2 is a drawing of a chromatographic column according to the invention;

FIG. 3 is a drawing of an embodiment of apparatus for the chromatographic separation of a mixture according to the invention;

FIG. 4 is a drawing of an embodiment of apparatus for the electrophoretic separation of a mixture according to the invention;

FIG. 5 is a drawing of a capillary column according to the invention; and

FIG. 6 is a drawing of an embodiment of apparatus according to the invention for selectively absorbing at least one component comprised in a sample mixture.

FIG. 7 is a plot of the efficiency of various chromatographic columns operated under ambient temperature conditions against the percentage of diamond particles they contain;

FIG. 8 is a plot of the efficiency of various chromatographic columns operated under adiabatic temperature conditions against the percentage of diamond particles they contain; and

FIG. 9 is a plot of the efficiencies of two chromatographic columns comprising different percentages of diamond particles against the flow rate of mobile phase.

### DETAILED DESCRIPTION OF EMBODIMENTS OF THE INVENTION

Embodiments of the present invention will be described in detail as to preferred devices, articles of manufacture and methods featuring a separation media. As used herein, unless the context requires otherwise, the term “column” refers to all separation devices having a conduit in which a separation media is placed, including column cartridges and capillaries. Those skilled in the art will recognise that the preferred embodiments of the present invention are capable of modification and alteration and that the present description should not be perceived as limiting.

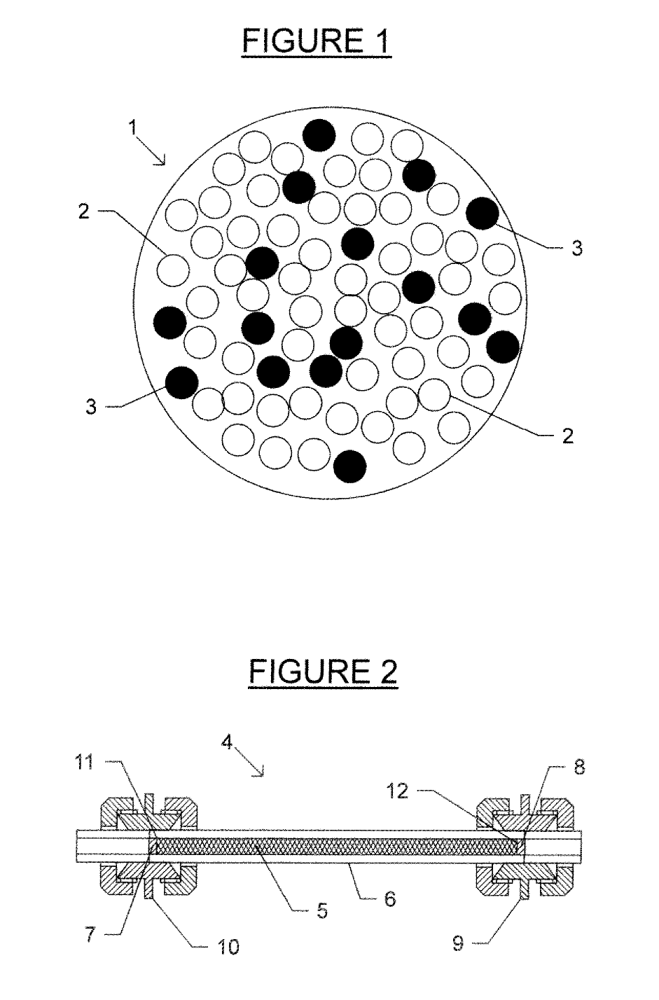

Turning now to FIG. 1, a separation media according to the invention, generally designated by the numeral 1, is depicted. The separation media 1 comprises a mixture of first particles 2 (represented by open circles) and second particles 3 (represented by filled circles). The second particles 3 have a higher thermal conductivity than the first particles 2. Preferably, the thermal conductivity of the material comprising the second particle is ten times greater than the material comprising the first particle. For example, the thermal conductivity of the material of the second particles 3 is preferably selected to be greater than 0.1 W·cm⁻¹ ·° K⁻¹, whereas the thermal conductivity of the material of the first particles 2 is typically about 0.01 W·cm⁻¹·° K⁻¹. The material of the first particle is selected for its affinity for the analyte. The material of the second particle is selected for the thermal conductivity. The addition of the second particles 3 to the first particles 2 increases the thermal conductivity of the separation media 1 beyond that of the first particles 2 alone.

Separation media provided by the invention has utility for chromatographic or electrophoretic separation of components of a sample mixture, or for the selective absorption of one or more components of a mixture on a substrate, typically prior to analysis of the absorbed components by another analytical technique. Preferably, the first particles are particles conventionally used for chromatographic separations or the selective absorption of different chemical species. For example, the first material from which the first particles are made may be chosen from the following list:
i. Silica;
ii. Glass;
iii. Graphite;
iv. Zirconia (zirconium oxide);
v. Organic polymers, for example cross-linked styrenes, methacrylate polymers, polyamides, etc;
vi. Alumina (aluminium oxide);
vii. Gels, for example polyacrylamide and derivatives thereof;
viii. Siliceous polymers, for example polyethoxysilane, and others described below;
ix. Titania (Titanium Dioxide);
x. Particles as listed above having surfaces modified with a variety of functional groups, for example hydrocarbon groups, including alkyl C₈ or C₁₈ groups, phenyl, aryl, or carbamate groups.

The above list is by way of example only and it is within the scope of the invention to provide first material comprising other materials capable of retaining or selectively absorbing components of a mixture.

The first particles have a diameter sized between 1 and 100 μm. For chromatographic embodiments, for example reverse-phase liquid chromatography, the first particles are between 1 and 10 μm. For extreme pressure applications, the first particles are sized less than 2 μm. The particles can be any shape including irregular shapes. Preferably, the particles are approximately spherical. The first particles are porous or non-porous, and, preferably, are porous.

The second material, from which the second particles are made, is selected to have a higher thermal conductivity than the first material from which the first particles are made. Typically, the second material may have a thermal conductivity in the range 0.1-50 W·cm⁻¹·° K⁻¹. The thermal conductivity of the second material is, preferably, selected to be ten-fold greater than the thermal conductivity of the material of the first particle. A preferred range is 1-10 W·cm⁻¹·° K⁻¹, to 1-50 W·cm⁻¹·° K⁻¹.

The second material is selected to have as little chromatographic effect. The addition of a second material type may influence peak shape unless the second material is relatively inert under the conditions used for the separation or absorption. The potential detrimental effect on peak shape is addressed by maintaining the concentration of the second particle as low as possible while taking advantage of the thermal conductivity.

Table 1 below lists some materials that may be considered for use as the second material of the invention, together with their approximate thermal conductivities. The list is not limiting, however, and other materials may be suitable.

TABLE 1
Thermal Conductivities of Some Materials

| Material | Thermal Conductivity (W · cm⁻¹ · °K⁻¹) |
|---|---|
| Silver | 4.3 |
| Copper | 4.0 |
| Aluminium | 2.4 |
| Gold | 3.2 |
| Tungsten | 1.8 |
| Molybdenum | 1.4 |
| Alumina | 0.2 |
| Aluminium nitride | 0.14-0.18 |
| Titanium Carbide | 0.56 |
| Silicon Carbide | 0.12 |
| Zirconium Oxide | 0.23 |
| Diamond | 10-26 |
| Graphite | 0.25-4.7 |

These thermal conductivities may be compared with the values for some commonly used chromatographic separation materials that might be used for the first particles, listed in Table 2 below:

TABLE 2
Approximate thermal conductivities of some chromatographic materials

| Particle Material | Thermal Conductivity (W · cm⁻¹ · °K⁻¹) |
|---|---|
| Silica | 0.01 |
| Glass | 0.004-0.01 |
| Carbon (graphite) | 0.25-4.7 |
| Cross-linked styrenes | <0.005 |

It can be seen from Tables 1 and 2 that the addition of second particles selected from table 1 to those listed in table 2 can markedly increase the thermal conductivity of the resulting media, especially when the second material has a very high thermal conductivity, such as diamond, gold, or certain forms of graphite.

Embodiments of separation media according to the invention suitable for chromatographic separations comprise a mixture of first and second particles comprising, for example, 1%-25% by volume of the second particles and the remainder substantially comprising the first particles. Preferably, the second particles comprise between 5% and 20% of the separation media. A concentration of second particles of approximately 10% of the separation media is a reasonable compromise with respect to the advantages of reducing thermal gradients and providing an appropriate well defined peak.

A preferred separation media has first particles of a hybrid siliceous polymer and second particles of gold, diamond, or graphite. The hybrid siliceous particles may be a methylpolyethoxysilane (structure I below) or a polyethoxysilane, (structure II below). Structure I:

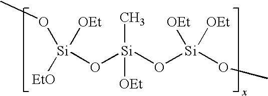

### Structure II:

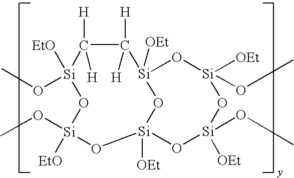

The open valences above are terminal hydrogen, or alkylene, alkynylene, or arylene groups or are bonded to further subgroups of the structures depicted. As used above, x and y are integers from 1 to infinity.

Alternatively, they may comprise any of the polymers described in U.S. Pat. No. 6,686,035, the contents of which are herein incorporated by reference. These polymers may be represented by the formulae SiO₂/[R²ₚR⁴_{q}SiOₜ]ₙ and SiO₂/[R⁶(R²ᵣSiOₜ)ₘ]ₙ, where R² and R⁴ are independently C₁-C₁₈ aliphatic or aromatic moieties, R⁶ is a substituted or unsubstituted C₁-C₁₈ alkylene, alkynylene, or arylene moiety bridging two or more silicon atoms. The following also applies:
a. p+q=0, 1 or 2;
b. if p+q=1, t=1.5;
c. if p+q=2, t=1;
d. r=0 or 1;
e. if r=0, t=1.5;
f. if r=1, t=1;
g. m is an integer ≧2;
h. n is a number between 0.03 and 1.

These siliceous particles are coated or uncoated. As used herein, the term “coated” refers to having the surface bonded to one or more functional groups. These functional groups are selected for the chromatographic separation to be carried out. For example, their surfaces may be modified with hydrocarbon groups, including alkyl C₈ or C₁₈ groups, phenyl, aryl, or carbamate groups. Methods of preparing and coating these siliceous polymeric particles are disclosed in the above-referenced U.S. Pat. No. 6,886,035.

Particles of structure I and sizes between 5 μm and 25 μm are available in the form of “XTerra™” chromatographic columns from Waters Corporation, Milford, Mass. Particles of structure II having a size of 1.7 μm are also available in the form of “ACQUITY UPLC®” or “XBridge™” chromatographic columns from Waters Corporation. Both types of particles are available with a variety of organofunctional coatings.

Siliceous polymer separation media according to the invention is made by mixing the polymer particles described above with similar-sized particles selected from Table 2 above. Gold, graphite and diamond, as a material for second particles, is preferred. The media may comprise between 1 and 25% of the second particles. However, about 10% gold or diamond has been found to give good results.

Diamond particles suitable for use in separation media according to the invention comprise natural diamond or high-pressure synthetic diamond manufactured by chemical vapour deposition (CVD) induced by RF, microwave, electron cyclotron resonance (ECR), etc, or by ion sputtering processes. Suitable diamond particles are commercially available, for example from Element Six, Netherlands.

Turning now to FIG. 2, apparatus for the chromatographic separation of a mixture, a chromatographic column, generally designated by the numeral 4, is depicted. Column 4 comprises a stainless steel tubular member 6 packed with separation media 5 as described above. The separation media 5 is confined within the tubular member 6 by means of porous frits 7 and 8 respectively located at the inlet 11 and outlet 12 of the tubular member 6. Pipe connections 10 are provided at each end of the tubular member 6 to allow the column to be installed in otherwise conventional liquid chromatographic apparatus.

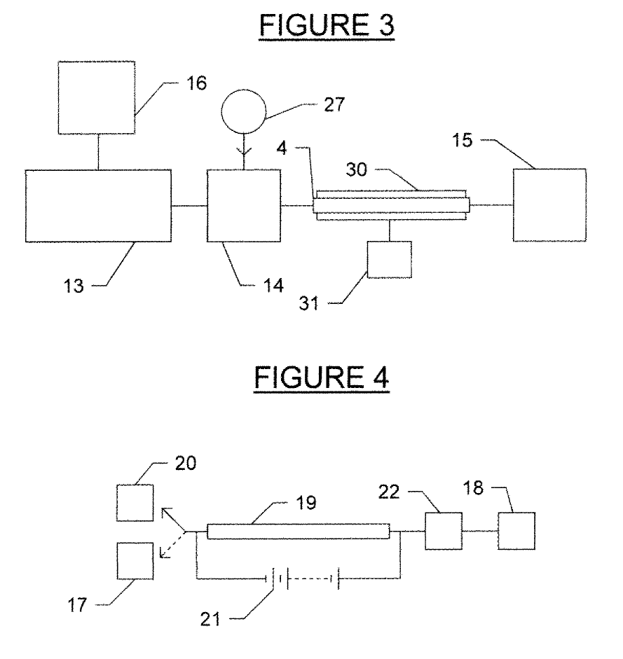

Turning now to FIG. 3, a high-pressure liquid chromatography (HPLC) system embodying features of the present invention, generally designated by the numeral 111, is depicted. HPLC analytical system 111 comprises the following major elements: a high-pressure pump 13, a sample injection device 14 and a detector or collector 15. The HPLC system has a chromatographic column 4 in fluid communication with the sample injection device 14, high-pressure pump 13, and detector or collector 15.

The sample injection device 14 is used to introduce a sample from a reservoir 27 into the flow of mobile phase from the pump 13. Constituents of a mobile phase (which may comprise a mixture of several solvents and/or additives) are stored in a reservoir system 16. The pump 13 is provided to pump the mobile phase through the column 4, and may be capable of providing to the column 4 a mobile phase whose composition varies with time, for example to allow gradient elution to be carried out. Eluent from the column 4 is received by a detector or collector system 15.

The HPLC system 111 may be used for either analytical purposes or preparative purposes. If used for analytical purposes, detector system 15 may comprise a detector responsive to at least one of the components comprised in a sample mixture to be analysed. Suitable detectors include UV absorption detectors, evaporative light scattering detectors, refractive index detectors, fluorescence detectors, electrochemical detectors, or mass spectrometric detectors. If the apparatus is to be used to prepare samples of constituents comprised in a sample mixture, detector system 15 may comprise a non-destructive detector such as a UV absorption detector, and a number of vessels or a sample plate comprising a number of wells, each vessel or well for receiving a particular constituent as it elutes from the column 4.

Means may also be provided to minimize the temperature gradient along the axis of the tubular member 6, which may otherwise develop due to the flow of mobile phase through the separation media 5. An insulated jacket 30 comprising a heater and one or more temperature sensors may be disposed around the tubular member 6. A temperature controller 31 may also be provided to control the power supplied to the heater in response to a signal from the one or more temperature sensors so that the temperature of the tubular member 6 is maintained approximately constant along at least a substantial portion of its length. In the alternative, in the event the components being separated are heat sensitive, the heater may be replaced by one or more cooling devices (for example, Peltier effect devices) and the temperature controller 31 adjusted to maintain the temperature of the tubular member 6 below ambient.

Alternative methods of minimizing the temperature gradient along the tubular member 6, comprise, by way of example, without limitation, immersion of tubular member 6 in a temperature-controlled water bath, or subjecting the tubular member 6 to a flow of heated (or cooled) air from a fan.

HPLC systems 111 for carrying out a high-resolution analytical separations are sold by several vendors, such as the ALLIANCE® and ACQUITY UPLC® systems available form Waters Corporation (Milford. MA). HPLC systems 111 for preparative uses are sold by several vendors such as the Delta 600 fluid handling unit also available from Waters Corporation.

FIG. 4 is a schematic drawing of a capillary electrophoresis apparatus, generally designated by the numeral 112. A capillary column 19 (described in detail below) comprising separation media according to the invention is disposed between reservoirs 18 and 20, each containing a buffer solution. A high-voltage power supply 21 is connected as shown to provide a potential difference of up to 30 kV (dependent on the nature of the buffer solution and the separation media) across the ends of the column 19. This potential difference provides an electromigratory force that causes the buffer solution to flow from the reservoir 20 to the reservoir 18 via a detector 22. A sample mixture is introduced into a third reservoir 17 that also contains buffer solution. In order to analyse the sample, the power supply 21 is switched off and the reservoir 17 (containing a sample) is substituted in place of the reservoir 20. Power supply 21 is then switched on so that the sample-bearing buffer solution is driven onto the column 19. Reservoir 17 is then replaced by reservoir 20 (containing only the buffer solution). The separation is continued so that the constituents of the sample are separated in time and pass in sequence through the detector 19.

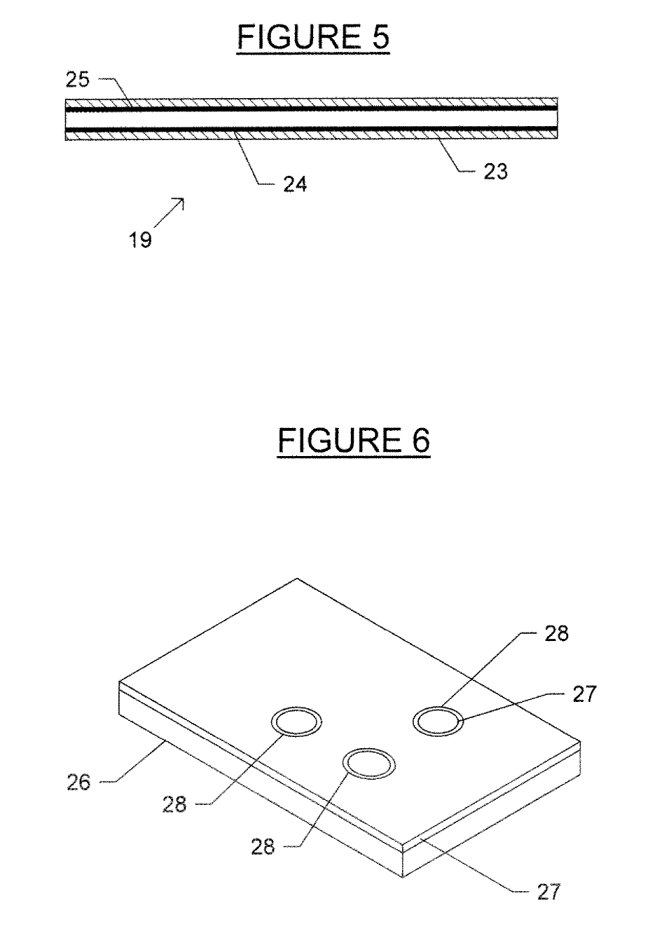

A suitable column 19 for use in the apparatus of FIG. 4 is shown in FIG. 5. A fused silica capillary tube 23 has an internal surface 24 on which a coating 25 is applied. The coating 25 may comprise separation media as described. For example, the coating 25 may comprise a mixture of first particles of a siliceous polymer and second particles of diamond. The coating 25 can be applied by any method conventionally employed for coating capillary columns using separation media according to the invention. The capillary tube 23 is between 10 and 100 cm long, a diameter of approximately 25 to 250 μm and an external diameter of 200 to 500 μm. A typical capillary tube 23 has a internal diameter of 75 μm and a external diameter of 375 μm.

One embodiment of the present invention features a capillary columns similar to capillary column 19, shown in FIG. 5, in place of the column 4 depicted in the apparatus 111 shown in FIG. 3.

An embodiment of the invention for selectively absorbing one or more constituents of a sample mixture is illustrated in FIG. 6. It comprises a plate substrate 26 to which a coating 27 is applied. The coating 27 comprises separation media as described above. Substrate 26 is any suitable material such as glass, quartz, silica, stainless steel, synthetic diamond, ceramic materials such as titanium carbide, or a plastic material. The substrate 26 is in the form of a plate, as depicted, or a rod, or a solid body of any convenient shape. Plate 26 has one or more wells 28, the interior of which has a coating 27. Each well 28 is constructed and arranged to receive a fluid sample. The coating 27 is the separation media according to the invention.

The separation media is of any of the forms described, however, for this discussion the separation media will be described as being chemically modified in order to provide selective absorption of a desired chemical species. For example, linker moieties are provided in a manner known in the art to attach antibodies to the surface. The antibodies have specific affinity to selected haptens, often proteins, so that particular proteins can be retained on the coating through an immunological interaction. This embodiment can be used to extract specific chemical species or even specific molecules from a complex mixture for analytical or preparative purposes. The higher thermal conductivity of coatings allow for distribution and dissipation of thermal energy. The plates 26 are used for matrix laser desorption ionization (MALDI) processes.

In the alternative, the coating 27 is a gel, for example a polyacrylamide gel, allowing the apparatus to be used for gel electrophoresis. In such an embodiment, the first particles of the invention may comprise polyacrylamide to which second particles of gold or diamond are added to increase the thermal conductivity of the gel.

Substrate 26 of the FIG. 6 apparatus may be made from the same material used for the coating 27, especially if the material comprises both the first and second particles of the invention and also a filer or a binding agent.

Embodiments of the invention according to FIG. 6 may be used for MALDI or laser desorption mass spectroscopy, where the improved thermal conductivity of plates according to the invention has been found to be especially valuable. They may also be used as sample receptacles useful in combinatorial chemistry experiments, especially when configured as multiple well plates.

In the alternative, solid substrates 26 according to the invention are be produced in granular or powder form with chemically modified surfaces that allow the grains to selectively adsorb specific types of chemical species. These embodiments may be used to extract species that are selectively absorbed on them from complex mixtures.

### Example

Four 50 mm long chromatographic columns, listed in Table 3 below, were packed using a downward slurry packing method with mixtures of “ACQUITY UPLC®” 1.7 μm BEH particles (structure II above, and available from Waters corporation, Milford, Mass.) and various proportions of non-porous, irregularly shaped 1.5-2.5 μm diamond particles.

TABLE 3

| | Internal | % of diamond |
|---|---|---|
| Col. No | diameter (mm) | particles |
| 1 | 3.0 | 0 |
| 2 | 3.0 | 1 |
| 3 | 3.0 | 5 |
| 4 | 3.0 | 10 |

For the following experiments, a mobile phase comprising 65% acetonitile, 35% water was used. A test sample comprising 9.6 μg/ml thiourea, 0.77 mg/ml toluene, 96 μg/ml naphthalene, 384 μg/ml acenaphthene, 500 μg/ml benzene, 0.1 μl/ml heptanophenone and 3 μl/ml amylbenzene, was used to obtain the results listed below. A sample loop of 2 μl volume was employed, and detection was by a UV absorbance detector tuned to 254 nm. A Waters corporation “ACQUITY UPLC®” pump system was used.

Data relevant to the performance of the four columns is listed in Table 4. The figures in table 4 relate to the heptanophenone component in the test sample. Data relating to “ambient” operation was obtained with the external surface of the columns in contact with ambient air, whereas the “adiabatic” data was obtained with the columns insulated from ambient air by layers of glass fibre tape. The retention factors listed have been corrected for extra-column contributions.

TABLE 4

| | | Theoretical | Retention | Theoretical |
|---|---|---|---|---|
| | Retention Factor | Plates | Factor | Plates |
| Col. No. | (Ambient) | (Ambient) | (Adiabatic) | (Adiabatic) |
| 1 | 6.19 | 11493 | 6.16 | 12813 |
| 2 | 6.18 | 10259 | 6.05 | 11325 |
| 3 | 5.98 | 12487 | 6.04 | 13360 |
| 4 | 5.93 | 14103 | 5.87 | 14051 |

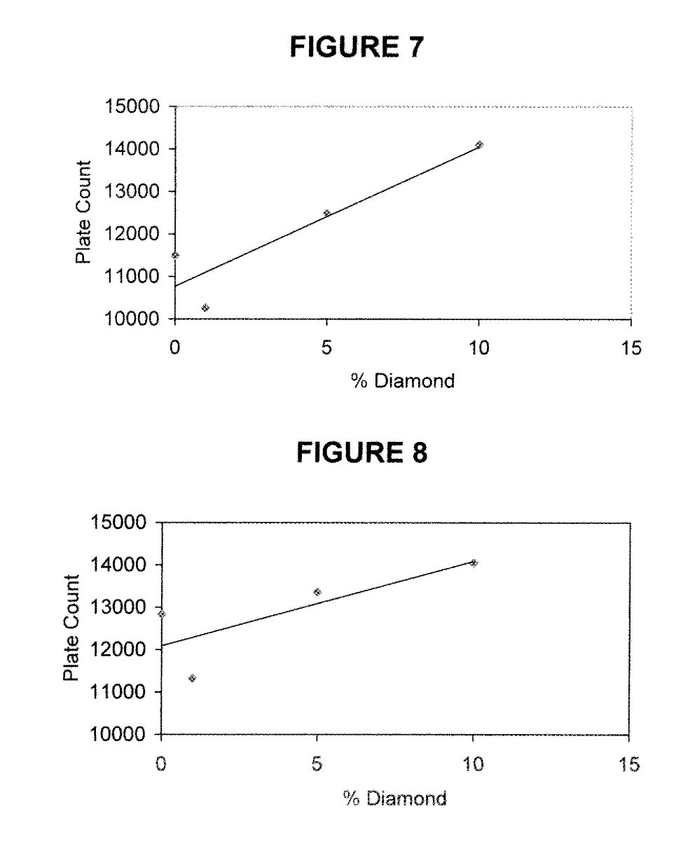

FIGS. 7 and 8 are plots of the column efficiency (as represented by the number of theoretical plates) against the percentage of diamond particles for columns 1-4 under ambient and adiabatic conditions, respectively. They, and the other figures in Table 4, show a clear trend of higher column efficiencies with the increasing percentage of diamond particles in the columns, particularly for the columns operated under “ambient” conditions (FIG. 7).

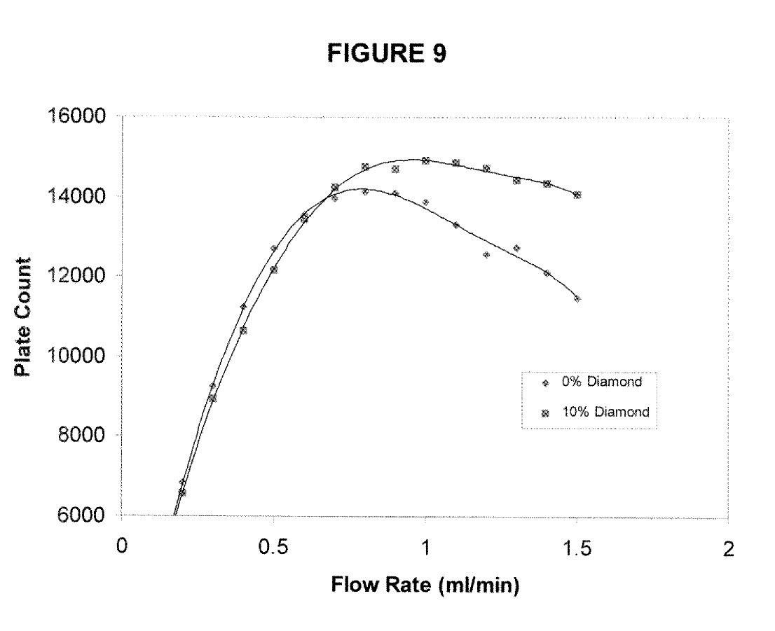

FIG. 9 is a plot showing the variation of column efficiency (as represented by the number of theoretical plates) with the flow rate of mobile phase, based on an analysis of the results for column no. 1 (comprising no diamond particles) and column no 4 (comprising 10% diamond particles), operated under “ambient” conditions. It is clear that the efficiency of column 4 is greater than that of column 1 at all but the lowest flow rates.

FIGS. 7 and 8 also show that greater increases in column efficiency are obtained when columns are operated under “ambient” temperature conditions than under “adiabatic” conditions.

What is claimed is:

1. Separation media for use in the chromatographic separation of a sample mixture, said separation media comprising first particles of a first material and second particles of a second material, said first particles being capable of at least temporarily retaining at least one of component of a sample mixture, and said second material being selected to have a higher thermal conductivity than said first material.

2. Separation media as claimed in claim 1 wherein said first material is selected from the group comprising: silica, glass, graphite, zirconia (zirconium oxide), organic polymers, alumina (aluminium oxide), gels, and siliceous polymers.

3. Separation media as claimed in claim 1 wherein first material is selected from the group comprising cross-linked styrenes, methacrylate polymers and polyamides.

4. Separation media as claimed in claim 1 wherein said first material comprises a polyacrylamide gel.

5. Separation media as claimed in claim 1 wherein said first material comprises a siliceous polymer represented by the formula SiO₂/[R²ₚR⁴_{q}SiOₜ]ₙ, where R² and R⁴ are independently C₁-C₁₈ aliphatic or aromatic moieties, p+q=0, 1 or 2, provided that t=1.5 if p+q=1 and t=1 if p+q=2, and n is a number between 0.03 and 1.

6. Separation media as claimed in claim 1 wherein said first material comprises a siliceous polymers represented by the formula SiO₂/[R⁶ (R²ᵣSiOₜ)ₘ]ₙ, where R² is C₁-C₁₈ aliphatic or aromatic moiety, R⁶ is a substituted or unsubstituted C₁-C₁₈ alkylene, alkynylene, or arylene moiety bridging two or more silicon atoms, r=0 or 1, provided that t=1.5 if r=0 and t=1 if r=1, m is an integer ≧2, and n is a number between 0.03 and 1.

7. Separation media as claimed in claim 1 wherein said first material comprises a siliceous polymer having a structure represented by: 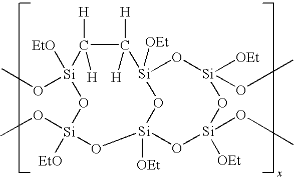
The open valences above are terminal hydrogen, or alkylene, alkynylene, or arylene groups or are bonded to further subgroups of the structure depicted. As used above, x is an integer from 1 to infinity.

8. Separation media as claimed in claim 1 wherein said first material comprises a siliceous polymer having a structure represented by: 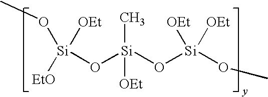
The open valences above are terminal hydrogen, or alkylene, alkynylene, or arylene groups or are bonded to further subgroups of the structure depicted. As used above, y is an integer from 1 to infinity.

9. Separation media as claimed in claim 2 wherein said first particles comprise surfaces modified with functional moieties selected from the group comprising alkyl moieties, phenyl moieties, aryl moieties, or carbamate moieties.

10. Separation media as claimed in claim 3 wherein said first particles comprise surfaces modified with functional moieties selected from the group comprising alkyl moieties, phenyl moieties, aryl moieties, or carbamate moieties.

11. Separation media as claimed in claim 5 wherein said first particles comprise surfaces modified with functional moieties selected from the group comprising alkyl moieties, phenyl moieties, aryl moieties, and carbamate moieties.

12. Separation media as claimed in claim 6 wherein said first particles comprise surfaces modified with functional moieties selected from the group comprising alkyl moieties, phenyl moieties, aryl moieties, and carbamate moieties.

13. Separation media as darned in claim 1 wherein said second material has a thermal conductivity in a range selected from the group comprising 0.1-0.5 W·cm⁻¹·° K⁻¹, 0.5-1.0 W·cm⁻¹·° K⁻¹, 1.0-10.0 W·cm⁻¹·° K⁻¹, and 10-50 W·cm⁻¹·K⁻¹.

14. Separation media as claimed in claim 1 wherein said second material is selected from the group comprising silver, copper, aluminium, gold, tungsten, molybdenum, alumina, aluminium nitride, titanium carbide, silicon carbide, zirconium oxide, diamond, and graphite.

15. Separation media as claimed in claim 1 wherein the proportion of second particles comprised in said separation media is between 1% and 25%.

16. Separation media as claimed in claim 1 wherein the proportion of second particles comprised in said separation media is between 5% and 20%.

17. Separation media as claimed in claim 1 wherein the proportion of second particles comprised in said separation media is approximately 10%.

18. Separation media as claimed in claim 5 wherein said second material is selected from the group comprising gold, diamond and graphite, and said first particles comprise surfaces modified with a functional moiety selected from the group comprising alkyl moieties, phenyl moieties, aryl moieties, and carbamate moieties.

19. Separation media as claimed in claim 6 wherein said second material is selected from the group comprising gold, diamond, and graphite, and said first particles comprise surfaces modified with a functional moiety selected from the group comprising alkyl moieties, phenyl moieties, aryl moieties, and carbamate moieties.

20. Apparatus for the chromatographic separation of a sample mixture comprising a tubular member having an inlet through which a fluid may enter and an outlet through which fluid may leave, said tubular member having an interior space disposed between said inlet and said outlet, wherein there is disposed in said interior space separation media comprising first particles of a first material and second particles of a second material, said first particles being capable of at least temporarily retaining at least one component of a said sample mixture and said second material being selected to have a higher thermal conductivity than said first material.

21. Apparatus as claimed in claim 20 wherein said first material is selected from the group comprising silica, glass, graphite, zirconia (zirconium oxide), organic polymers, alumina (aluminium oxide), gels, and siliceous polymers.

22. Apparatus as claimed in claim 20 wherein said second material is selected from the group comprising silver, copper, aluminium, gold, tungsten, molybdenum, alumina, aluminium nitride, titanium carbide, silicon carbide, zirconium oxide, diamond and graphite.

23. Apparatus as claimed in claim 20 wherein said first material comprise a siliceous polymer represented by the formula SiO₂/[R²ₚR⁴_{q}Sioₜ]ₙ, where R² and R⁴ are independently C₁-C₁₈ aliphatic or aromatic moieties, p+q=0, 1 or 2, provided that t=1.5 if p+q=1 and t=1 if p+q=2, and n is a number between 0.03 and 1.

24. Apparatus as claimed in claim 20 wherein said first material comprises a siliceous polymer represented by the formula SiO₂/[R⁶ (R²ᵣSiOₜ)ₘ]ₙ, where R² is C₁-C₁₈ aliphatic or aromatic moiety, R⁶ is a substituted or unsubstituted C₁-C₁₈ alkylene, alkynylene, or arylene moiety bridging two or more silicon atoms, r=0 or 1, provided that t=1.5 if r=0 and t=1 if r=1, m is an integer ≧2, and n is a number between 0.03 and 1.

25. Apparatus as claimed in claim 23 wherein said second material is selected from the group comprising gold, diamond, and graphite.

26. Apparatus as claimed in claim 24 wherein said second material is selected from the group comprising gold, diamond, and graphite.

27. Apparatus for selectively absorbing at least one component of a sample mixture on separation media, said apparatus comprising means for applying a fluid comprising a said sample mixture to said separation media, wherein said separation media comprises first particles of a first material and second particles of a second material, said first particles being capable of at least temporarily retaining at least one component of a said sample mixture and said second material being selected to have a higher thermal conductivity than said first material.

28. Apparatus as claimed in claim 27 wherein said first material is selected from the group comprising silica, glass, graphite, zirconia (zirconium oxide), organic polymers, alumina (aluminium oxide), gels, and siliceous polymers.

29. Apparatus as claimed in claim 27 wherein said second material is selected from the group comprising silver, copper, aluminium, gold, tungsten, molybdenum, alumina, aluminium nitride, titanium carbide, silicon carbide, zirconium oxide, diamond, and graphite.

30. Apparatus as claimed in claim 27 wherein said first material comprise a siliceous polymer represented by the formula SiO₂/[R²ₚR⁴_{q}SiOₜ]ₙ, where R² and R⁴ are independently C₁-C₁₈ aliphatic or aromatic moieties, p+q=0, 1 or 2, provided that t=1.5 if p+q=1 and t=1 if p+q=2, and n is a number between 0.03 and 1.

31. Apparatus as claimed in claim 27 wherein said first material comprises a siliceous polymer represented by the formula SiO₂/[R⁶ (R²ᵣSiOₜ)ₘ]ₙ, where R² is C₁-C₁₈ aliphatic or aromatic moiety, R⁶ is a substituted or unsubstituted C1-C₁₈ alkylene, alkynylene, or arylene moiety bridging two or more silicon atoms, r=0 or 1, provided that t=1.5 if r=0 and t=1 if r=1, m is an integer ≧2, and n is a number between 0.03 and 1.

32. Apparatus as claimed in claim 30 wherein said second material is selected from the group comprising gold, diamond and graphite.

33. Apparatus as claimed in claim 31 wherein said second material is selected from the group comprising gold, diamond and graphite.

34. Apparatus as claimed in claim 27 wherein said first material comprises is selected from the group comprising cross-linked styrenes, methacrylate polymers, polyamides and polyacrylamide gels.

35. Apparatus as claimed in claim 34 wherein said second material is selected from the group comprising silver, copper, aluminium, gold, tungsten, molybdenum, alumina, aluminium nitride, titanium carbide, silicon carbide, zirconium oxide, diamond and graphite.

36. Apparatus as claimed in claim 20 for the analysis of a sample mixture comprising one or more constituents, further comprising a high-pressure pump, a sample injection device, and a detector responsive to at least one constituent of a said sample mixture.

37. Apparatus as claimed in claim 36 wherein said first material is selected from the group comprising silica, glass, graphite, zirconia (zirconium oxide), organic polymers, alumina (aluminium oxide), gels, and siliceous polymers, and said second material is selected from the group comprising silver, copper, aluminium, gold, tungsten, molybdenum, alumina, aluminium nitride, titanium carbide, silicon carbide, zirconium oxide, diamond and graphite.

38. Apparatus as claimed in claim 20 wherein said tubular member is disposed between reservoirs, each containing a buffer solution, and a high-voltage power supply for applying a potential difference between said reservoirs so that said buffer solution flows through said tubular member.

39. Apparatus as claimed in claim 38 wherein said first material is selected from the group comprising silica, glass, graphite, zirconia (zirconium oxide), organic polymers, alumina (aluminium oxide), gels, and siliceous polymers, and said second material is selected from the group comprising silver, copper, aluminium, gold, tungsten, molybdenum, alumina, aluminium nitride, titanium carbide, silicon carbide, zirconium oxide, diamond and graphite.

40. Apparatus as claimed in claim 27 further comprising a high-voltage power supply and wherein said separation media is disposed on a substrate, and said high-voltage power supply provides a potential difference across said substrate, whereby components of a said sample mixture may be separated by electrophoresis.

41. Apparatus as claimed in claim 40 wherein said first material is selected from the group comprising silica, glass, graphite, zirconia (zirconium oxide), organic polymers, alumina (aluminium oxide), gels, and siliceous polymers, and said second material is selected from the group comprising silver, copper, aluminium, gold, tungsten, molybdenum, alumina, aluminium nitride, titanium carbide, silicon carbide, zirconium oxide, diamond and graphite.

42. Apparatus as claimed in claim 22 further comprising means for minimizing any temperature gradient in an axial direction along said tubular member.

43. Apparatus as claimed in claim 42 wherein said means for minimizing any temperature gradient comprises a jacket surrounding said tubular member and fitted with at least one heater and at least one temperature sensor, and a temperature controller responsive to signals from said at least one temperature sensor, said temperature controller for supplying and controlling power to said at least one heater.

44. Apparatus as claimed in claim 42 wherein said means for minimizing any temperature gradient comprises a jacket surrounding said tubular member and fitted with at least one cooling device and at least one temperature sensor, and a temperature controller responsive to signals from said at least one temperature sensor, said temperature controller for supplying and controlling power to said at least one cooling device.

45. Apparatus as claimed in claim 44 wherein said cooling device comprises a Peltier effect device.

46. Apparatus as claimed in claim 42 wherein said tubular member is immersed in a water bath.

47. Apparatus as claimed in claim 42 wherein said tubular member is subjected to a flow of air.

48. An apparatus for the chromatographic separation of a sample mixture comprising a tubular member having an inlet through which a fluid may enter and an outlet through which fluid may leave, said tubular member having an interior space disposed between said inlet and said outlet, wherein there is disposed in said interior space separation media comprising first particles of a first material and second particles of a second material, said first particles being capable of at least temporarily retaining at least one component of a said sample mixture and said second material being selected to have a higher thermal conductivity at least ten time greater than said first material and said second material is present in a concentration of between 1 and twenty-five percent by volume, wherein said first material is selected from the group consisting of silica, glass, graphite, zirconia (zirconium oxide), organic polymers, alumina (aluminium oxide), gels, and siliceous polymers and said second material is selected from the group comprising silver, copper, aluminium, gold, tungsten, molybdenum, alumina, aluminium nitride, titanium carbide, silicon carbide, zirconium oxide, diamond, and graphite.
